(19) United States
(12) Patent Application Publication
(10) Pub. No.: US 2013/0279725 A1
(43) Pub. Date: Oct. 24, 2013

(54) HEADPHONE DETECTION CIRCUIT AND ELECTRONIC DEVICE WITH HEADPHONE DETECTION CIRCUIT

(71) Applicants: DONG-LIANG REN, Shenzhen City (CN); KUO-PIN LIN, Tu-Cheng (TW)

(72) Inventors: DONG-LIANG REN, Shenzhen City (CN); KUO-PIN LIN, Tu-Cheng (TW)

(21) Appl. No.: 13/663,375

(22) Filed: Oct. 29, 2012

(30) Foreign Application Priority Data
Apr. 18, 2012 (CN) 201210114078.7

(51) Int. Cl. H04R 5/02

(52) U.S. Cl. 381/309

(57) ABSTRACT

A headphone detection circuit includes a voltage output module and a trigger signal producing module. The voltage output module is used to produce a first voltage to trigger an audio amplifier to output amplified left and right channel signals to a loudspeaker when the headphone port is not connected to the headphone, and produce a second voltage to trigger the audio amplifier to output the amplified left and right channel signals to the headphone port when the headphone port is connected to the headphone. The trigger signal producing module is used to trigger the processing unit to output left channel signals and right channel signals with a relative higher gain when receiving the first voltage, and trigger the processing unit to output the left channel signals and right channel signals with a relative lower gain when receiving the second voltage.

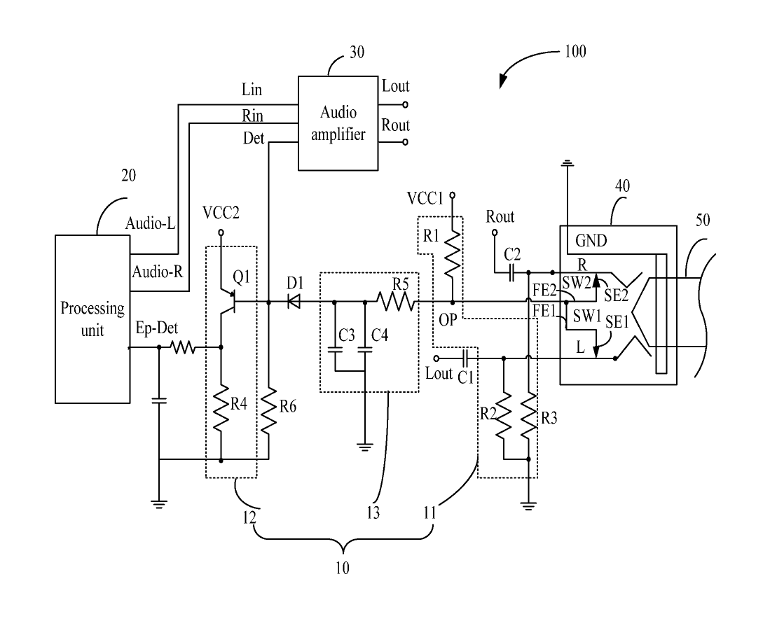

### BACKGROUND

1. Technical Field

The present disclosure relates to detection circuits, and particularly to a headphone detection circuit and an electronic device with the headphone detection circuit.

2. Description of Related Art

Electronic devices, such as mobile phones, digital cameras, electronic readers, digital photo frames, usually have an audio playing function. These electronic devices can output audio signals via a loudspeaker or a headphone. Usually, such an electronic device has a headphone detection circuit to detect whether or not a headphone is plugged into a headphone port of the electronic device. The electronic device increases the gain of the audio signals to enhance the volume when the headphone detection circuit does not detect the headphone is inserted into the headphone port. On the other hand, the electronic device also decreases the gain of the audio signals to decrease the volume when the headphone detection circuit detects that a headphone is inserted into the headphone port. However, the usual headphone detection circuit is complex.

Therefore, a headphone detection circuit and an electronic device with the headphone detection circuit, to overcome the described limitations are thus needed.

### BRIEF DESCRIPTION OF THE DRAWINGS

Many aspects of the present disclosure are better understood with reference to the following drawing. The components in the drawing are not necessarily drawn to scale, the emphasis instead being placed upon clearly illustrating the principles of the present disclosure. Moreover, in the drawing, like reference numerals designate corresponding parts throughout the view.

The FIGURE is a circuit diagram of an electronic device with an headphone detection circuit, in accordance with an exemplary embodiment.

### DETAILED DESCRIPTION

Embodiments of the present disclosure will be described with reference to the accompanying drawing.

The FIGURE illustrates an electronic device 100 of the embodiment. The electronic device 100 includes a headphone detection circuit 10, a processing unit 20, an audio amplifier 30, and a headphone port 40.

The headphone port 40 is used to connect to a headphone 50. The headphone detection circuit 10 is used to detect whether the headphone port 40 is connected to the headphone 50, namely whether the headphone 50 is inserted into the headphone port 40.

The processing unit 20 is used to play an audio file or a video file in response to an operation of a user, and output left channel signals and right channel signals with a certain gain corresponding to the audio file or video file. The audio amplifier 30 is connected to the processing unit 20 and is used to amplify the left channel signals and the right channel signals.

The headphone detection circuit 10 includes a voltage output module 11 and a trigger signal producing module 12. The voltage output module 11 is connected to the headphone port 40, and produces a first voltage when the headphone port 40 does not connect to the headphone 50, and produces a second voltage when the headphone port 40 is connected to the headphone 50.

The trigger signal producing module 12 is connected to the voltage output module 11 and the processing unit 20, and is used to output a loudspeaker trigger signal to the processing unit 20 when receiving the first voltage, and is used to output a headphone trigger signal to the processing unit 20 when receiving the second voltage.

The processing unit 20 outputs the left channel signals and the right channel signals with a relative higher gain when receiving the loudspeaker trigger signal, and output the left channel signals and the right channel signals with a relative lower gain when receiving the headphone trigger signal.

The audio amplifier 30 is also connected to the voltage output module 11, and is used to amplify the left channel signals and the right channel signals received from the processing unit 20 and output the amplified left channel signals and the right channel signals to a loudspeaker (not shown), when receiving the first voltage. The audio amplifier 30 is also used to amplify the left channel signals and the right channel signals received from the processing unit 20 and output the amplified left channel signals and the right channel signals to the headphone port 40, when receiving the second voltage.

Thus, when the headphone 50 is inserted into the headphone port 40, the electronic device 100 outputs the left channel signal and right channel signal with relative lower gain via the headphone port 40, and then to the headphone 40. When the headphone 50 is not inserted into the earphone port 40, the electronic device 100 outputs the left channel signals and right channel signals with relative higher gain via the loudspeaker.

In the embodiment, the audio amplifier 30 also can adjust the gain of the left channel signals and the right channel signals in response to the operation of the user, thus adjust the volume of the signals in response to the operation of the user.

In detail, as shown in the FIGURE, the processing unit 20 includes a left channel output pin Audio-L, a right channel output pin Audio-R, and a headphone detection pin Ep-Det. The audio amplifier 30 includes a left channel input pin Lin, a right channel input pin Rin, a left channel output pin Lout, a right channel output pin Rout, and a detection pin Det. The left channel input pin Lin of the audio amplifier 30 is connected to the left channel output pin Audio-L of the processing unit 20. The right channel input pin Rin of the audio amplifier 30 is connected to the right channel output pin Audio-R of the processing unit 20. The audio amplifier 30 receives the left channel signals and the right channel signals from the processing unit 20 respectively via the left channel input pin Lin and the right channel input pin Rin, and outputs the amplified left channel signals and the right channel signals respectively via the left channel output pin Lout and the right channel output pin Rout.

The headphone port 40 includes a ground pin GND, a left channel pin L, a right channel pin R, and two switch pins SW1, SW2. The switch pin SW1 includes a first end FE1, and a second end SE1, the switch SW2 includes a first end FE2 and a second end SE2. The first end FE1 of the switch pin SW1 is fixed connected to the first end FE2 of the switch pin SW2, the second end SE1 of the switch SW1 can contact with the left channel pin L or detach from the left channel pin L of the headphone port 40. The second end SE2 of the switch SW2 can contact with the right channel pin R or detach from the right channel pin R of the headphone port 40.

The left channel pin L and the right channel pin R of the headphone port 40 are respectively connected to left channel output pin Lout and the right channel output pin Rout of the audio amplifier 30, and respectively receives the amplified left channel signals and the amplified right channel signals from the left channel output pin Lout and the right channel output pin Rout of the audio amplifier 30.

In the embodiment, the headphone detection circuit 10 also includes a first capacitor C1 and a second capacitor C2. The first capacitor C1 is connected between the left channel output pin Lout of the audio amplifier 30 and the left channel pin L of the headphone port 40, and is used to filter direct current signals from the amplified left channel signals. The second capacitor C2 is connected between the right channel output pin Rout of the audio amplifier 30 and the right channel pin R of the headphone port 40, and is used to filter direct current signals from the amplified right channel signals.

The voltage output module 11 includes a first resistor R1, a second resistor R2, and a third resistor R3. One end of the first resistor R1 is connected between a first voltage port VCC1 and the other end of the first resistor R1 is connected to the first end FE1 of the switch pin SW1 and the first end FE2 of the switch pin SW2. The second resistor R2 is connected between the left channel pin L and ground. The third resistor R3 is connected between the right channel pin R and ground. Resistance values of the second resistors R2 and R3 are both much less than a resistance value of the first resistor R1. For example, the resistance value of the first resistor R1 is 10 K ohm and the resistance value of the second resistors R2 and R3 both is 1 K ohm. An end of the first resistor R1 connected to the switch pin SW1 constitutes an output port OP of the voltage output module 11. The output port OP of the voltage output module 11 is electrically connected to the detection pin Det.

In the embodiment, the first voltage output by the voltage output module 11 is a low voltage and the second voltage output by the voltage output module 11 is a high voltage.

When the headphone 50 is not inserted into the headphone port 40, the switch pins SW1, SW2 respectively contact to the left channel pin L and the right channel R of the headphone port 40. Therefore, the second resistor R2 and the resistor R3 are connected in parallel between the first resistor R1 and the ground via the two switch pins SW1, SW 2. Then, a voltage of the second resistor R2 is equal to a voltage of the third resistor R3, the voltage output by the output port OP of the voltage output module 11 is equal to the voltage of the second resistor R2 and is equal to the voltage the parallel third resistor R3. Assume the voltage of the first voltage port VCC1 is 5 volts, the resistance value of the first resistor R1 is 10K ohms, and the resistance value of the second resistor R2 and the third resistor R3 both are 1K ohms, then the voltage output by the output port OP of the voltage output module 11 is 5*0.5/10.5=0.238 volt. Usually, 0.228 volt is a low voltage, that is, the voltage output by the output port OP outputs the low voltage, namely the first voltage.

When the headphone 50 is inserted into the headphone port 40, the headphone 50 pushes the left channel pin L and the right channel pin R of the headphone port 40 and causes the switch pins SW1 and SW2 to be respectively detached from the first channel pin L and the right channel pin R. The output port OP of the voltage output module 11 obtains the voltage of the first voltage port VCC1 via the first resistor R1 and outputs the high voltage, namely, the second voltage.

The audio amplifier 30 outputs the amplified left channel signals and the amplified right channel signals to the loudspeaker when the detection pin Det receives the low voltage signal from the voltage output module 11. The audio amplifier 30 outputs the amplified left channel signals and the amplified right channel signals to the headphone port 40 when the detection pin Det receives the high voltage signal from the voltage output module 11.

The trigger signal producing module 12 includes a positive-negative-positive bipolar junction transistor (PNP BJT) Q1 and a fourth resistor R4. An emitter of the PNP BJT Q1 is connected to a second voltage port VCC2, a collector of the PNP BJT Q1 is grounded via the fourth resistor R4, and a base of the PNP BJT Q1 is electrically connected to the output port OP of the voltage output module 11. The collector of the PNP BJT Q1 is also electrically connected to the headphone detection pin Ep-Det of the processing unit 20. In another embodiment, the PNP BJT Q1 can be instead by a P-channel metal-oxide-semiconductor field-effect transistor. In the embodiment, the loudspeaker trigger signal is a high voltage signal and the headphone trigger signal is a low voltage signal.

As described above, when the headphone 50 is not inserted into the headphone port 40, the voltage output module 11 outputs the low voltage, then the base of the PNP BJT Q1 receives the low voltage and the PNP BJT Q1 is turned on accordingly. The headphone detection pin Ep-Det obtains the voltage of the second voltage port VCC2 via the PNP BJT Q1 which is turned on and at high voltage. Then, the headphone detection pin Ep-Det obtains the high voltage signal, namely the loudspeaker trigger signal. Then the processing unit 20 output the left channel signals and right channel signals with the relative higher gain when the headphone detection pin Ep-Det obtains the loudspeaker trigger signal. In the embodiment, the voltage of the first voltage port VCC1 and the second voltage port VCC2 both are 5 volts.

When the headphone 50 is inserted into the headphone port 40, as described above, the voltage output module 11 outputs the high voltage, then the base of the PNP BJT Q1 receives the high voltage and the PNP BJT Q1 is turned off accordingly. The headphone detection pin Ep-Det is grounded via the fourth resistor R4 and obtains a low voltage. Then the headphone detection pin Ep-Det obtains the low voltage signal, namely the headphone trigger signal. The processing unit 20 outputs the left channel signals and right channel signals with the relative lower gain when the headphone detection pin Ep-Det obtains the headphone trigger signal.

In the embodiment, the headphone detection circuit 10 also includes a filter circuit 13, the filter circuit 13 is connected between the voltage output module 11 and the trigger signal producing module 12. In detail, the filter circuit 13 is connected between the output port OP of the voltage output module 11, the detection pin Det of the audio amplifier 30, and the base of the PNP BJT Q1. The filter circuit 13 includes a fifth resistor R5, a third capacitor C3, and a fourth capacitor C4. Usually, at the moment that the headphone 50 is pulled out from into the headphone port 40, the audio amplifier 30 maintains to output the amplified left channel signals and the right channel signals to the left channel pin L and the right channel pin R for a very short moment. The filter circuit 13 is used to filter the left channel signals and the right channel signals received by the headphone port 40 and prevents the left channel signals and the right channel signals to be transmitted to the detection pin Det of the audio amplifier 30 and the trigger signal producing module 12, thereby ensuring the voltage output module 11 outputs the low voltage signal when the headphone 50 is not inserted into the headphone port 40.

In the embodiment, the headphone detection circuit 10 also includes a diode D1 and other components according to the need. The diode D1 is used to prevent the current from flowing from the trigger signal producing module 12 to the voltage output module 11.

In the embodiment, the electronic device 100 can be any electronic device with the audio playing function, such as a mobile phone, a digital photo frame, an electronic reader, a tablet computer, for example.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A headphone detection circuit comprising:
a voltage output module, to be connected to a headphone port and an audio amplifier of an electronic device, configured to produce a first voltage to trigger the audio amplifier to output amplified left channel signals and right channel signals to a loudspeaker when the headphone port does not connected to the headphone, and configured to produce a second voltage to trigger the audio amplifier to output the amplified left channel signals and right channel signals to the headphone port when the headphone port is connected to the headphone; and
a trigger signal producing module, connected to the voltage output module and a processing unit, configured to output a loudspeaker trigger signal to the processing unit when receiving the first voltage, thereby triggering the processing unit to output left channel signals and right channel signals with a relative higher gain; and configured to output a headphone trigger signal to the processing unit when receiving the second voltage, thereby triggering the processing unit to output left channel signals and right channel signals with a relative lower gain;
wherein, the processing unit outputs the left channel signals and right channel signals with the relative higher gain or relative lower gain by playing an audio file in response to an operation of a user, the audio amplifier receives the left channel signals and right channel signals output from the processing unit and amplifies the left channel signals and right channel signals to obtain the amplified left channel signals and right channel signals.

2. The headphone detection circuit according to claim 1, wherein the voltage output module comprises a first resistor, a second resistor, and a third resistor, one end of the first resistor is connected to a first voltage port and the other end of the first resistor is connected to first ends of a first switch pin and a second switch pin of the headphone port, the second resistor is connected between a left channel pin of the headphone port and ground, the third resistor is connected between the right channel pin of the headphone port and ground.

3. The headphone detection circuit according to claim 2, wherein, the end of the first resistor connected to the first ends of the first switch pin and the second switch pin of the headphone port constitutes an output port of the voltage output module and is connected to a detection pin of the audio amplifier.

4. The headphone detection circuit according to claim 3, wherein the trigger signal producing module comprises a positive-negative-positive bipolar junction transistor (PNP BJT) and a fourth resistor, an emitter of the PNP BJT is connected to a second voltage port, a collector of the PNP BJT is grounded via the fourth resistor, a base of the PNP BJT is electrically connected to the output port of the voltage output module, the collector of the PNP BJT is further electrically connected to a headphone detection pin of the processing unit.

5. The headphone detection circuit according to claim 4, wherein resistance values of the first resistor and the second resistor are both much less than a resistance value of the first resistor, the first voltage is a low voltage and the loudspeaker trigger signal is a high voltage signal; when a headphone is not inserted into the headphone port, the first switch pin is contacted with the left channel pin of the headphone port, the second switch pin of the headphone port is contacted with the right channel pin of the headphone port, the output port of the voltage output module outputs the low voltage, the base of the PNP BJT receives the low voltage and causes the PNP BJT to turn on accordingly, then the headphone detection pin of the processing unit obtains the high voltage signal from the second voltage port via the PNP BJT which is turned on.

6. The headphone detection circuit according to claim 4, wherein the second voltage is a high voltage and the headphone trigger signal is a low voltage signal, when a headphone is inserted into the headphone port, the first switch pin is detached from the left channel pin of the headphone port, the second switch pin of the headphone port is detached from the right channel pin of the headphone port, the output port of the voltage output module is electrically connected to the first voltage port via the first resistor and outputs the high voltage, the base of the PNP BJT receives the high voltage and cause the PNP BJT to turn off accordingly, the headphone detection pin of the processing unit is grounded via the fourth resistor and obtains the low voltage signal.

7. The headphone detection circuit according to claim 1, further comprising a filter circuit, wherein the filter circuit is connected between the voltage output module, the trigger signal producing module, and the audio amplifier.

8. An electronic device comprising:
a headphone port, configured to connect to a headphone;
a processing unit, configured to outputs left channel signals and right channel signals by playing an audio file in response to an operation of a user;
an audio amplifier, connected to the headphone port and the processing unit, configured to receive the left channel signals and right channel signals output from the processing unit and amplify the left channel signals and right channel signals to obtain amplified left channel signals and right channel signals; and
a headphone detection circuit, comprising:
a voltage output module, connected to the headphone port and the audio amplifier, configured to produce a first voltage when the headphone port does not connected to the headphone, and configured to produce a second voltage when the headphone port is connected to the headphone; and
a trigger signal producing module, connected to the voltage output module and a processing unit, configured to output a loudspeaker trigger signal to the processing unit when receiving the first voltage; and output a headphone trigger signal to the processing unit when receiving the second voltage;
wherein, the processing unit outputs left channel signals and right channel signals with a relative higher gain when receiving the loudspeaker trigger signal and outputs left channel signals and right channel signals with a relative lower gain when receiving the headphone trigger signal; the audio amplifier outputs the amplified left channel signals and right channel signals to a loudspeaker when receiving the first voltage and outputs the amplified left channel signals and right channel signals to the headphone port when receiving the second voltage.

9. The electronic device according to claim 8, wherein the headphone port comprises a ground pin, a left channel pin, a right channel pin, a first switch pin and a second switch pin, the first switch pin and the second switch pin both comprises a first end and a second end, the first end of the first switch pin is fixed connected to the first end of the second switch pin; when the headphone is not inserted into the headphone port, the second end of the first switch pin is contacted with the left channel pin, the second end of the second switch pin is contacted with the right channel pin; when the headphone is inserted into the headphone port, the second end of the first switch pin is detached from the left channel pin and the second end of the second switch pin is detached with the right channel pin.

10. The electronic device according to claim 9, wherein the voltage output module comprises a first resistor, a second resistor, and a third resistor, one end of the first resistor is connected between a first voltage port and the other end of the first resistor is connected to the first ends of the first switch pin and the second switch pin of the headphone port, the second resistor is connected between the left channel pin of the headphone port and ground, the third resistor is connected between the right channel pin of the headphone port and ground.

11. The electronic device according to claim 10, wherein, the end of the first resistor connected to the first ends of the first switch pin and the second switch pin of the headphone port constitutes an output port of the voltage output module and is connected to a detection pin of the audio amplifier.

12. The electronic device according to claim 11, wherein the trigger signal producing module comprises a positive-negative-positive bipolar junction transistor (PNP BJT) and a fourth resistor, an emitter of the PNP BJT is connected to a second voltage port, a collector of the PNP BJT is grounded via the fourth resistor, a base of the PNP BJT is electrically connected to the output port of the voltage output module, the collector of the PNP BJT is further electrically connected to a headphone detection pin of the processing unit.

13. The electronic device according to claim 12, wherein resistance values of the first resistor and the second resistor are both much less than a resistance value of the first resistor, the first voltage is a low voltage and the loudspeaker trigger signal is a high voltage signal; when the headphone is not inserted into the headphone port, the second resistor and the resistor are paralleled connected between the first resistor and the ground, a voltage of the output port of the voltage output module is equal to a voltage of the second resistor and the third resistor and outputs the low voltage; the base of the PNP BJT receives the low voltage and cause the PNP BJT to turn on accordingly, then the headphone detection pin of the processing unit obtains the high voltage signal from the second voltage port via the PNP BJT which is turned on.

14. The electronic device according to claim 12, wherein the second voltage is a high voltage and the headphone trigger signal is a low voltage signal, when a headphone is inserted into the headphone port, the output port of the voltage output module is electrically connected to the first voltage port via the first resistor and outputs the high voltage, the base of the PNP BJT receives the high voltage and cause the PNP BJT to turn off accordingly, the headphone detection pin of the processing unit is grounded via the fourth resistor and obtains the low voltage signal.

15. The electronic device according to claim 8, wherein the headphone detection circuit further comprises a filter circuit, the filter circuit is connected between the voltage output module, the trigger signal producing module, and the audio amplifier.

16. The electronic device according to claim 8, wherein the electronic device is one selected from the group consisting of a mobile phone, a digital phone frame, an electronic reader, a tablet computer, and a digital camera.
